(19) United States
(12) Patent Application Publication
(10) Pub. No.: US 2021/0343304 A1
(43) Pub. Date: Nov. 4, 2021

(54) Method for Improving Voice Call Quality, Terminal, and System

(71) Applicant: Huawei Technologies Co., Ltd., Shenzhen, Guangdong (CN)

(72) Inventors: Fengguang Qiu, Shanghai (CN); Wei Li, Shenzhen (CN); Bao Wang, Shanghai (CN); Fei Liu, Shanghai (CN)

(21) Appl. No.: 17/261,746

(22) PCT Filed: Aug. 31, 2018
(86) PCT No.: PCT/CN2018/103638

§ 371 Date: Jan. 20, 2021

(51) Int. Cl. G10L 21/02

(52) U.S. Cl. CPC G10L 21/02

(57) ABSTRACT

Embodiments of the present invention provide a method for improving voice call quality. The method is applied to a terminal, and the terminal includes a buffer module. When the buffer module includes voice data, the method includes: determining that the voice data buffered by the buffer module is in an accumulated state; and cutting off an SID frame in the voice data. To be specific, when the SID frame is detected and the voice data buffered by the buffer module is in the accumulated state, the SID frame in the voice data is cut off. The SID frame does not include semantic data. In this way, an amount of to-be-sent voice data is reduced, a packet loss and a sending delay are reduced, voice call quality is improved, and user experience is improved.

### TECHNICAL FIELD

This application relates to the voice field, and in particular, to a method for improving voice call quality, a terminal, and a system.

### BACKGROUND

A voice call in a VoIP scenario, for example, VOLTE, namely, voice over LTE (voice over LTE), is an IP multimedia subsystem (IP multimedia subsystem, IMS)-based voice service. The voice call in the VoIP scenario is an IP data transmission technology, does not require a 2G/3G CS network, and becomes a standard architecture of a core network in an all-IP era based on a PS domain network. After decades of development and maturity, the IMS has crossed a chasm and becomes a mainstream choice for VoBB and PSTN network reconstruction in a fixed voice field. In addition, the IMS has been determined as a standard architecture of a mobile voice in 3GPP and GSMA. With the VoLTE technology, a 4G user waits a shorter time before a call is connected and experience higher-quality and more natural audio and video calls.

However, during a VoLTE call, voice data is accumulated in a buffer of a terminal. Consequently, a delay in sending data from the terminal to a base station is caused, a packet loss occurs on the terminal, a voice packet loss and discontinuity are caused, and user experience is poor.

### SUMMARY

The present invention provides a method for improving voice call quality, a terminal, and a system, to resolve a problem that in a scenario in which an uplink coverage is limited or a capacity is insufficient, voice data is accumulated on a terminal and cannot be sent in a timely manner, causing a voice packet loss and discontinuity.

According to a first aspect, a method for improving voice call quality is provided. The method is applied to a terminal, the terminal includes a buffer module, and when the buffer module includes voice data, the method includes:
determining that the voice data buffered by the buffer module is in an accumulated state; and
cutting off an SID frame in the voice data, where the SID frame does not include semantic data.

When the SID frame is detected and the voice data buffered by the buffer module is in the accumulated state, the SID frame in the voice data is cut off. In this way, an amount of to-be-sent voice data is reduced, a packet loss and a sending delay are reduced, voice call quality is improved, and user experience is improved.

With reference to the first aspect, in a first possible implementation of the first aspect, the determining that the voice data buffered by the buffer module is in an accumulated state includes:
when buffer duration of the voice data buffered by the buffer module meets a first preset threshold, determining that the voice data buffered by the buffer module is in the accumulated state.

With reference to the first aspect, in a second possible implementation of the first aspect, the determining that the voice data buffered by the buffer module is in an accumulated state includes:
when a ratio of buffer duration of the voice data buffered by the buffer module to maximum allowable buffer duration meets a second preset threshold, determining that the voice data buffered by the buffer module is in the accumulated state, where the maximum allowable buffer duration is used to limit the buffer duration of the buffered voice data.

With reference to any one of the first aspect or the possible implementations of the first aspect, in a third possible implementation of the first aspect, the cutting off an SID frame in the voice data includes:
when at least N consecutive SID frames are detected, starting cutting from the (N+1)^{th} SID frame until buffer duration of the buffer module meets a third preset threshold, or until a speech frame is detected, where N is a positive integer, and N is greater than or equal to 0.

With reference to any one of the first aspect or the possible implementations of the first aspect, in a fourth possible implementation of the first aspect, before the determining that the voice data buffered by the buffer module is in an accumulated state, the method further includes:
receiving the maximum allowable buffer duration sent by an apparatus, where the maximum allowable buffer duration is used to limit the buffer duration for buffering voice data by the terminal.

With reference to any one of the first aspect or the possible implementations of the first aspect, in a fifth possible implementation of the first aspect, the method further includes:
discarding voice data whose buffer duration exceeds the maximum allowable buffer duration in the buffer module, where the maximum allowable buffer duration is used to limit the buffer duration for buffering the voice data.

With reference to any one of the first aspect or the possible implementations of the first aspect, in a sixth possible implementation of the first aspect, the method further includes:
receiving authorization information sent by the apparatus; and
determining a quantity of to-be-sent bytes based on the authorization information, obtaining, from buffered data, voice data corresponding to the quantity of to-be-sent bytes, and sending the voice data to the apparatus.

With reference to any one of the first aspect or the possible implementations of the first aspect, in a seventh possible implementation. of the first aspect, the voice data may be voice data of a 5G call or voice data of a video call.

According to a second aspect, a terminal is provided. The terminal includes a buffer unit and a processing unit. The buffer unit may be referred to as a buffer module.

When the terminal transmits voice data, the processing unit is configured to determine that voice data buffered by the buffer module is in an accumulated state.

The processing unit cuts off an SID frame in the voice data. The SID frame does not include semantic data.

When the SID frame is detected and the voice data buffered by the buffer module is in the accumulated state, the SID frame in the voice data is cut off. In this way, an amount of to-be-sent voice data is reduced, a packet loss and a sending delay are reduced, voice call quality is improved, and user experience is improved.

With reference to the second aspect, in a first possible implementation of the second aspect, that the processing unit is configured to determine that the voice data buffered by the buffer module is in the accumulated state includes:
when buffer duration of the voice data buffered by the buffer module meets a first preset threshold, the processing unit determines that the voice data buffered by the butler module is in the accumulated state.

With reference to the second aspect, in a second possible implementation of the second aspect, that the processing unit is configured to determine that the voice data buffered by the buffer module is in the accumulated state includes:
when a ratio of buffer duration of the voice data buffered by the buffer module to maximum allowable buffer duration meets a second preset threshold, the processing unit is configured to determine that the voice data buffered by the buffer module is in the accumulated state, where the maximum allowable buffer duration is used to limit the buffer duration of the buffered voice data.

With reference to any one of the second aspect or the possible implementations of the second aspect, in a third possible implementation of the second aspect, that the processing unit cuts off an SID frame in the voice data includes:
when at least N consecutive SID frames are detected, the processing unit starts cutting from the (N+1)^{th} SID frame until buffer duration of the buffer module meets a third preset threshold, or until a speech frame is detected, where N is a positive integer, and N is greater than or equal to 0.

With reference to any one of the second aspect or the possible implementations of the second aspect, in a fourth possible implementation of the second aspect, the terminal may further include a transceiver unit, and before that the voice data buffered by the huller module is in the accumulated state is determined,
the transceiver unit is configured to receive the maximum allowable buffer duration sent by an apparatus, where the maximum allowable buffer duration is used to limit the buffer duration for buffering voice data by the terminal.

With reference to any one of the second aspect or the possible implementations of the second aspect, in a fifth possible implementation of the second aspect, the processing unit is further configured to:
discard voice data whose buffer duration exceeds the maximum allowable buffer duration in the buffer module, where the maximum allowable buffer duration is used to limit the buffer duration for buffering the voice data.

With reference to any one of the second aspect or the possible implementations of the second aspect, in a sixth possible implementation of the second aspect, the terminal further includes the transceiver unit;
a receiving unit is configured to receive authorization information sent by the apparatus; and
the processing unit is configured to: determine a quantity of to-be-sent bytes based on the authorization information, obtain, from buffered data, voice data corresponding to the quantity of to-be-sent bytes, and send the voice data to the apparatus.

With reference to any one of the second aspect or the possible implementations of the second aspect, in a seventh possible implementation of the second aspect, the voice data may be voice data of a 5G call or voice data of a video call.

According to a third aspect, a terminal is provided, including a buffer and a processor. The processor is coupled to a memory, and when the buffer includes voice data, the processor reads and executes an instruction in the memory, to implement the following operations:
determining that voice data buffered by a buffer module is in an accumulated state; and
cutting an SID frame in the voice data, where the SID frame does not include semantic data.

When the SID frame is detected and the voice data buffered by the buffer module is in the accumulated state, the SID frame in the voice data is cut off. In this way, an amount of to-be-sent voice data is reduced, a packet loss and a sending delay are reduced, voice call quality is further improved, and user experience is improved.

With reference to the third aspect, in a first possible implementation of the third aspect, the determining that voice data buffered by a buffer module is in an accumulated state includes:
when buffer duration of the voice data buffered by the buffer module meets a first preset threshold, determining that the voice data buffered by the buffer module is in the accumulated state.

With reference to the third aspect, in a second possible implementation of the third aspect, the determining that voice data buffered by a buffer module is in an accumulated state includes:
when a ratio of buffer duration of the voice data buffered by the buffer module to maximum allowable buffer duration meets a second preset threshold, determining that the voice data buffered by the buffer module is in the accumulated state, where the maximum allowable buffer duration is used to limit the buffer duration of the buffered voice data.

With reference to any one of the third aspect or the possible implementations of the third aspect, in a third possible implementation of the third aspect, the cutting off an SID frame in the voice data includes:
when at least N consecutive SID frames are detected, starting cutting from the (N+1)^{th} SID frame until buffer duration of the buffer module meets a third preset threshold, or until a speech frame is detected, where N is a positive integer, and N is greater than or equal to 0.

With reference to any one of the third aspect or the possible implementations of the third aspect, in a fourth possible implementation of the third aspect, before the determining that voice data buffered by a buffer module is in an accumulated state, the processor reads and executes the instruction in the memory, to implement the following operation:
receiving the maximum allowable buffer duration sent by an apparatus, where the maximum allowable buffer duration is used to limit the buffer duration for buffering voice data by the terminal.

With reference to any one of the third aspect or the possible implementations of the third aspect, in a fifth possible implementation of the third aspect, before the determining that voice data buffered by a buffer module is in an accumulated state, the processor reads and executes the instruction in the memory, to implement the following operation:
discarding voice data whose buffer duration exceeds the maximum allowable buffer duration in the buffer module, where the maximum allowable butler duration is used to limit the buffer duration for buffering the voice data.

With reference to any one of the third aspect or the possible implementations of the third aspect, in a sixth possible implementation of the third aspect, the processor reads and executes the instruction in the memory, to implement the following operations:
receiving authorization information sent by the apparatus; and
determining a quantity of to-be-sent bytes based on the authorization information, obtaining, from buffered data, voice data corresponding to the quantity of to-be-sent bytes, and sending the voice data to the apparatus.

With reference to any one of the third aspect or the possible implementations of the third aspect, in a seventh possible implementation of the third aspect, the terminal further includes the memory.

With reference to any one of the third aspect or the possible implementations of the third aspect, in an eighth possible implementation of the third aspect, the voice data may be voice data of a 5G call or voice data of a video call.

According to a fourth aspect, a system is provided. The system includes the terminal according to any one of the third aspect or the possible implementations of the third aspect and an apparatus. The apparatus is configured to receive voice data sent by the terminal.

With reference to the fourth aspect, in a possible implementation, the apparatus is a base station or a server.

According to a fifth aspect, a computer readable storage medium is provided. The computer readable storage medium stores a computer program, and when the computer program is executed by a processor, the method according to any one of the first aspect or the possible implementations of the first aspect is implemented.

According to a sixth aspect, a computer program product including an instruction is provided. When the instruction is run on a computer, the computer is enabled to perform the method according to any one of the first aspect or the possible implementations of the first aspect.

According to the provided method for improving voice call quality, the terminal, and the system, when the SID frame is detected and the voice data buffered by the buffer module is in the accumulated state, the SID frame is cut off, so that a data amount of a to-be-sent voice is reduced without affecting semantics. In this way, a quantity of packets that are actively discarded by the terminal and a data sending delay are reduced, and user experience is improved.

### BRIEF DESCRIPTION OF DRAWINGS

FIG. 1 is a schematic diagram of voice data transmission according to an embodiment of the present invention;

FIG. 2 is another schematic diagram of voice data transmission according to an embodiment of the present invention;

FIG. 3 is a schematic diagram of voice data transmission according to an embodiment of the present invention;

FIG. 4 is a schematic flowchart of a method for improving voice call quality according to an embodiment of the present invention;

FIG. 5 is a schematic flowchart of another method for improving voice call quality according to an embodiment of the present invention;

FIG. 6 is a schematic diagram of voice data buffered before and after an SID frame is cut off according to an embodiment of the present invention;

FIG. 7 is a schematic structural diagram of a terminal according to an embodiment of the present invention; and

FIG. 8 is a schematic structural diagram of another terminal according to an embodiment of the present invention.

### DESCRIPTION OF EMBODIMENTS

The following describes the solutions in the embodiments of the present invention with reference to the accompanying drawings.

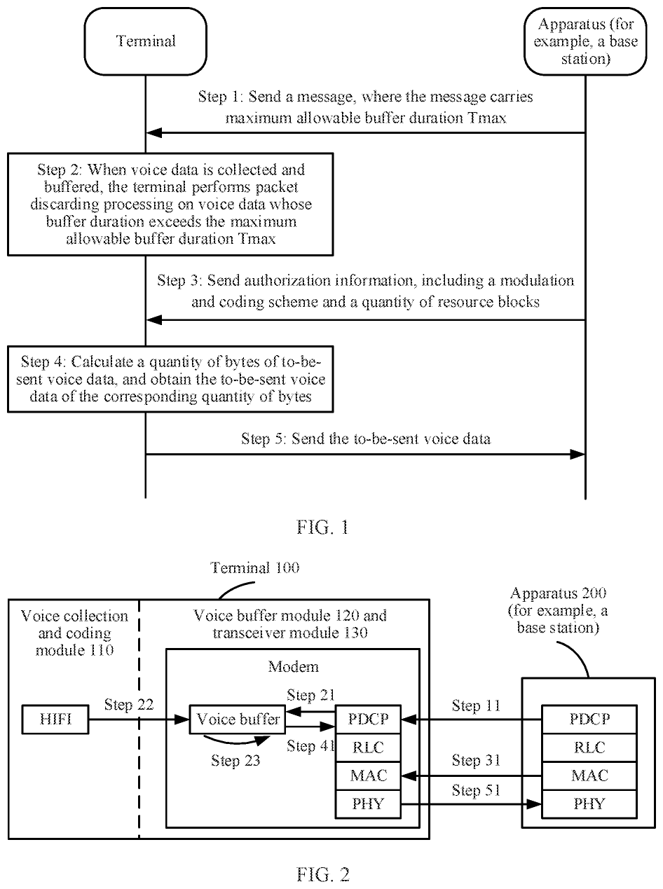

FIG. 1 is a schematic diagram of voice data transmission according to an embodiment of the present invention. As shown in FIG. 1, devices involved in the voice data transmission include a terminal 100 and an apparatus 200. In this embodiment of the present invention, the apparatus 200 may be a base station, or may be a server, for example, a server used for uplink transmission, for example, a server of a live broadcast website used by a streamer.

In this embodiment, an example in which the apparatus 200 is a base station is used for description. A voice data transmission process specifically includes the following steps:

Step 1: The base station sends a message to the terminal, where the message carries maximum allowable buffer duration Tmax,

Step 2: When the terminal collects and buffers voice data, the terminal performs packet discarding processing on voice data whose buffer duration exceeds the maximum allowable buffer duration Tmax.

Step 3: The base station sends authorization information to the terminal. The authorization information may include a modulation and coding scheme (modulation and coding scheme, MCS) and a quantity of resource blocks (resource block, RB). The MCS and the RB are used to calculate a quantity of bytes of to-be-sent voice data.

Step 4: The terminal calculates, based on the MCS and the RB, the quantity of bytes of the to-be-sent voice data, and obtains the to-be-sent voice data corresponding to the quantity of bytes.

Step 5: The terminal sends the to-be-sent voice data to the base station.

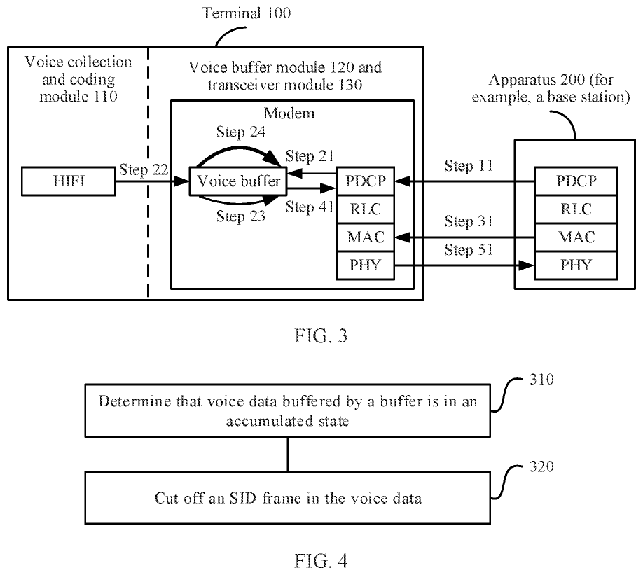

A specific process of each step in FIG. 1 may be completed by using a system shown in FIG. 2. As shown in FIG. 2, the terminal 100 may include a voice collection and coding module 110, a voice buffer module 120, and a transceiver module 130. The voice collection or coding module 110 may be a high-fidelity (high-fidelity, HIFI) device. The voice buffer module 120 and the transceiver module 130 may be a modem (modem).

Step 11: The base station sends a message to the terminal by using a packet data convergence protocol (packet data convergence protocol, PDCP), Where the message carries the maximum allowable buffer duration Tmax.

Step 21: The terminal sends the maximum allowable buffer duration Tmax to the voice buffer module 120.

The terminal receives, by using the PDCP layer, the message sent by the base station, where the message carries the maximum allowable buffer duration Tmax. The terminal sends the maximum allowable buffer duration Tmax to the voice buffer module 120.

Step 22: The voice buffer module 120 receives and buffers voice data sent by the voice collection and coding module 110.

Step 23: The voice buffer module 120 performs packet discarding processing on voice data whose buffer duration exceeds the maximum allowable buffer duration Tmax.

For example, the maximum allowable buffer duration Tmax=800 ms. The voice buffer module 120 discards voice data whose buffer duration exceeds 800 ms, to meet a requirement of the maximum allowable buffer duration.

Step 31: The base station sends the authorization information to the terminal by using a media access control (media access control, MAC) layer, where the authorization information includes the MCS and the quantity of RBs, so that the terminal calculates, based on the MCS and the quantity of RBs, the quantity of bytes of the to-be-sent voice data.

Step 41: The terminal calculates, based on the MCS and the quantity of RBs. the quantity of bytes of the to-be-sent voice data, and obtains, from a voice data buffer module by using the PDCP, the to-be-sent voice data corresponding to the quantity of bytes.

The to-be-sent voice data is packaged by using the PDCP, a radio link control (radio link control, RLC) layer, the MAC layer, a physical layer, and the like, and is finally sent to the base station. That is, step 51 is performed.

Step 51: The terminal sends the to-be-sent voice data to the base station by using the PHY layer.

Then, the base station receives, by using the PHY layer, the to-be-sent voice data sent by the terminal, to complete transmission of the voice data.

It should be noted that each step in FIG. 2 is a specific implementation process of the step in FIG. 1. Step 11 in FIG. 2 is a specific implementation process of step 1 in FIG. 1. Step 21, step 22, and step 23 in FIG. 2 are a specific implementation process of step 2 in FIG 1. Step 31 in FIG. 2 is a specific implementation process of step 3 in FIG. 1. Step 41 in FIG. 2 is a specific implementation process of step 4 in FIG. 1. Step 51 in FIG. 2 is a specific implementation process of step 5 in FIG. 1.

It should he further noted that sequence numbers of the steps in FIG. 1 and FIG. 2 do not indicate an execution sequence. The execution sequence of the processes should be determined based on functions and internal logic of the processes, and should not be construed as any limitation on the implementation process of this embodiment of the present invention.

In FIG. 1 and FIG. 2, the voice data sent by the terminal 100 is based on authorization of the base station. In this case, in a scenario in which an uplink coverage is limited or a capacity is insufficient, if authorization granted by the base station. to the terminal is less than a voice collection bit rate of the terminal, the voice data is accumulated in a buffer of the terminal and cannot be sent in a timely manner, causing an end-to-end delay. If buffer duration exceeds timeout duration sent by the base station to the terminal, the terminal actively discards a voice packet, causing a voice packet loss and discontinuity, and poor user experience.

To reduce an amount of discarded voice data and improve quality of voice data, the following functions are added to the terminal: determining whether buffered voice data is in an accumulated state; and cutting off an SID frame when the buffered data is in the accumulated state, so as to cut off an SID frame in the voice data without affecting semantics, thereby reducing an amount of to-be-sent voice data in the buffer, reducing a packet loss amount of the terminal, and reducing a sending delay of the voice data.

The voice data includes the SID frame and a speech frame. The speech frame is a data frame including actual semantic data. The SID frame is a data frame that does not include actual semantics but may include some signals such as noise.

Specifically, as shown in FIG. 3, step 24 is added to the terminal to determine whether the buffered voice data is in the accumulated state. The SID frame is cut off when the buffered data is in the accumulated state.

It should be noted that in this embodiment of the present invention, the voice buffer module may also be referred to as a buffer module. The buffer module may be specifically a buffer, a memory, or a modem, or a part of a memory or a modem. The voice data in this embodiment of the present invention may be 2G/3G voice data, or may be VoLTE (voice to LTE) voice data. VoLTE is an IP multimedia subsystem (IP multimedia subsystem, IMS)-based voice service, and is an IP data transmission technology, where all services are carried in a 4G network. The voice data may alternatively be voice data of a 5G call (VoNR) or voice data of a video call. The VoNR is voice over 5G, that is, 5G new radio (new radio, NR), namely 5GNR.

In this embodiment of the present invention, voice call quality is improved by using step 24 in FIG. 3. The following describes the process in detail with reference to FIG. 4.

FIG. 4 is a schematic flowchart of a method for improving voice call quality according to an embodiment of the present invention. As shown in FIG. 4, the method may include the following steps.

S310: A terminal determines that voice data buffered by a buffer module is in an accumulated state.

In this embodiment of the present invention, when the buffer module includes the voice data, the terminal determines whether the voice data buffered by the buffer module is in the accumulated state.

Optionally, in an embodiment, when buffer duration of the voice data buffered by the buffer module meets a first preset threshold, it is determined that the voice data buffered by the buffer module is in the accumulated state; or when buffer duration of the voice data buffered by the buffer module does not meet a first preset threshold, it is determined that the voice data buffered by the buffer module is not accumulated.

In an embodiment, for example, when the buffer duration of the voice data buffered by the buffer module is greater than the first preset threshold (for example, 500 ms), it is determined that the voice data buffered by the buffer module is in the accumulated state; or when the buffer duration of the voice data buffered by the buffer module is less than or equal to the first preset threshold, it is determined that the voice data buffered by the buffer module is not accumulated.

Optionally, in another embodiment, when a ratio of buffer duration of the voice data buffered by the buffer module to maximum allowable buffer duration meets a second preset threshold, it is determined that the voice data buffered by the buffer module is in the accumulated state or when a ratio of buffer duration of the voice data buffered by the buffer module to maximum allowable buffer duration does not meet a second preset threshold, it is determined that the voice data buffered by the buffer module is not accumulated. The maximum allowable buffer duration is maximum allowable butler duration that is received by the terminal and that is delivered by an apparatus, for example, as shown in step 1 in FIG. 1 or step 11 in step 2.

In an embodiment, for example, when the ratio of the buffer duration T of the voice data buffered by the buffer module to the maximum allowable butler duration Tmax exceeds the second preset threshold R (for example, R=0.08), that is, T/Tmax>0.08, it is determined that the voice data buffered by the buffer module is in the accumulated state; or when the ratio does not exceed the second preset threshold R, it is determined that the voice data buffered by the buffer module is not accumulated.

In this embodiment of the present invention, the first preset threshold and the second preset threshold may be customized based on a requirement. This is not limited in this embodiment of the present invention.

S320: The terminal cuts off an SID frame in the voice data.

The voice data includes a speech frame and the SID frame. The SID frame does not include semantic data. The semantic data is data including voice content, for example, data including call content or voice content in a call, a voice call, or a video call. A data frame that includes semantic data is referred to as a speech frame, and on the contrary, a data frame that does not include semantic data is referred to as an SID frame. The SID frame does not include semantic data, but may include some interference data such as noise.

The terminal detects the voice data buffered in the buffer module. When detecting that the voice data includes consecutive SID frames, for example, when detecting at least N consecutive SID frames, where N is a positive integer, and N is greater than or equal to 0, the terminal starts cutting from the (N+1)^{th} SID frame until buffer duration of voice data currently buffered by the buffer module meets a third preset threshold, or until a next frame is a speech frame.

In an embodiment, for example, when the buffer duration of the voice data buffered by the buffer module is less than the third preset threshold (for example, 300 ms), the terminal stops cutting off the SID frame.

Then, voice data whose buffer duration exceeds the maximum allowable buffer duration is discarded, and voice data of a corresponding quantity of bytes is obtained based on the quantity of bytes of to-be-sent data and is sent to the apparatus. This reduces a packet loss of the terminal and a sending delay, improves voice call quality, and improves user experience.

It should be noted that in this embodiment of the present invention, the third preset threshold is less than the maximum allowable buffer duration.

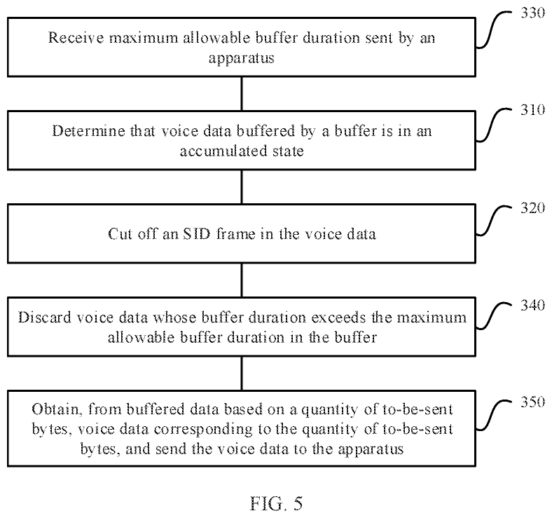

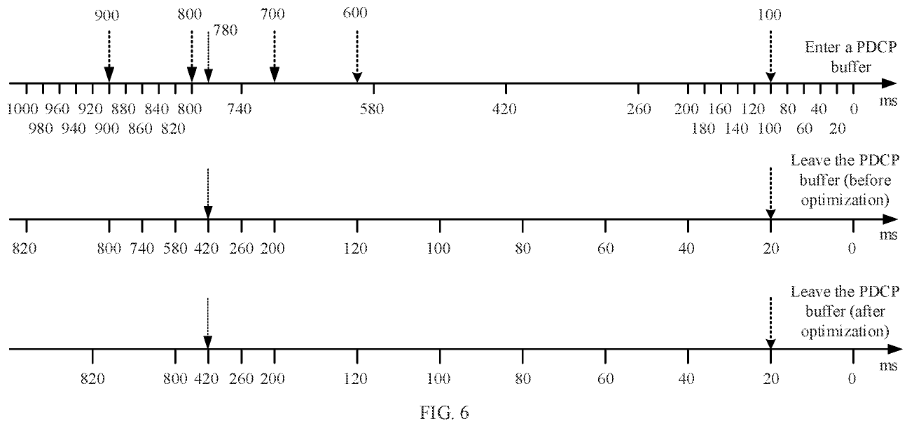

Optionally, in this embodiment of the present invention, as shown in FIG. 5, before it is determined that the voice data buffered by the buffer module is in the accumulated state, the method may further include the following step:

S330: The terminal receives the maximum allowable buffer duration sent by the apparatus.

The maximum allowable buffer duration is used to limit the buffer duration for buffering voice data by the terminal.

Optionally, as shown in FIG. 5, the method further includes the following steps.

S340: The terminal discards the voice data whose buffer duration exceeds the maximum allowable buffer duration in the buffer module.

S340 may be performed at any moment. The voice data is discarded provided that the buffer duration of the voice data buffered by the buffer module exceeds the maximum allowable buffer duration.

S350: The terminal receives authorization information sent by the apparatus.

When the apparatus is a base station, the authorization information may include an MCS and RB data, and is used by the terminal to calculate, based on the MCS and the RB data, a quantity of bytes that can be sent.

S360: The terminal obtains, from buffered data based on the quantity of to-be-sent bytes, voice data corresponding to the quantity of to-be-sent bytes, and sends the voice data to the apparatus.

In this embodiment of the present invention, the apparatus may alternatively be a server used for uplink transmission, for example, a server of a live broadcast website used by a streamer. When the apparatus is a server, S310, S320, S330, S340, and S350 in FIG. 5 may also be performed, to improve voice call quality and further improve user experience.

Sequence numbers of the foregoing processes do not mean execution sequences in the embodiments of the present invention. The execution sequences of the processes should be determined based on functions and internal logic of the processes, and should not be construed as any limitation on the implementation processes of the embodiments of the present invention.

The following provides an actual example. FIG. 6 is a schematic diagram of buffering voice data before and after an SID frame is cut off. In FIG. 6, description is provided by using an example in which voice transmission duration is 100 ms and mute transmission duration is 40 ms. FIG. 6 is a schematic diagram of a time point at which voice data enters a PDCP buffer, a schematic diagram of a time point at which voice data leaves the PDCP buffer before optimization, and a schematic diagram of a time point at which voice data leaves the PDCP buffer after optimization.

In FIG. 6, one speech frame is generated every 20 ms. In generation of an SID frame, a generation interval between the first SID frame and the second SID frame is 60 ms. After the second frame, one SID frame is generated every 160 ms. It is assumed that maximum allowable buffer duration Tmax=500 ms.

In the schematic diagram of the time point at which the voice data enters the PDCP buffer in FIG. 6, speech frames are enqueued and buffered at the time points of 20 ms, 40 ms, 60 ms, 80 ms, 10 ms, 120 ms, 140 ms, 160 ms, and 180 ms, SID frames are enqueued and buffered at the time points of 200 ms, 260 ms, 420 ms, 580 ms, and 740 ms. At 800 ms and after 800 ms, speech frames are enqueued and buffered every 20 ms.

Because the voice transmission duration is 100 ms, three speech frames that are enqueued at the time points of 140 ms, 160 ms, and 180 ms can be sent only at time points of 700 ms, 800 ms, and 900 ms. The three speech frames are actively discarded by the terminal before and after optimization because buffer duration of the three speech frames exceeds the maximum allowable buffer duration of 500 ms.

If at least N consecutive SID frames are detected in five SID frames that are enqueued and buffered at the time points of 200 ms, 260 ms, 420 ms, 580 ms, and 740 ms, and data buffered at the PDCP layer in the N^{th} frame exceeds a threshold T1, an SID frame starts to be cut off from the (N+1)^{th} frame. In this embodiment of the present invention, it is assumed that N=3 and T1=300 ms. The first three consecutive SID frames enqueued at the time points of 200 ms, 260 ms, and 420 ms are not cut off, SID frames enqueued from the time point of 580 ms may be cut off, and whether the two SID frames enqueued at the time points of 580 ms and 740 ms need to be cut off needs to be determined based on whether buffer duration of the SID frame enqueued at the time point of 420 ms exceeds the threshold T1. In this case, the SID frame enqueued at the time point of 420 ms can be sent only at a time point of 780 ms (in the schematic diagram of a time point at which voice data leaves the PDCP before optimization in FIG. 6). Therefore, buffer duration of the SID frame enqueued at the time point of 420 ms is 780−420=360 (ms). Because 360 ms exceeds the threshold T1=300 ms, the two SID frames enqueued at the time points of 580 ms and 740 ms need to be cut off. A schematic diagram in which voice data leaves the PDCP buffer after the SID frames are cut off is the schematic diagram of a time point at which voice data leaves the PDCP buffer after optimization. It is clear that after the SID frames are cut off, a data amount of to-be-sent voice data is reduced, a packet loss of the terminal and a delay in sending the voice data are also reduced, voice call quality is further improved, and user experience is improved.

The following uses an adaptive multi-rate narrowband (adaptive multi-rate narrowband, amr-NB) and an adaptive multi-rate wideband (adaptive multi-rate wideband, AMR-WB) as examples to describe a reason why voice quality can be improved by cutting an SID frame. A minimum packet size of an SID frame at Layer 2 is 7 (AMR-NBs)+5 (robust header compression (robust header compression. RoHC) internet protocol (interact protocol, IP)/user datagram protocol (user datagram protocol UDP)/real-time transport protocol (real-time transport protocol, RTP) header)+3 (PDCP+RLC+MAC header)=15 bytes. In VoLTE, a coding scheme used for the AMR-NB is 12.2 kpbs. In VoLTE, a coding scheme used for the AMR-WB is 23.85 kbps.

A minimum packet size of AMR-NB 12.2 kbps at Layer 2 is 32+5+3=40 bytes. When AMR-NB is used, a main scenario is mode —set=7, that is, a rate cannot be adjusted.

A minimum packet size of AMR-WB with a maximum rate 23.85 kbps at Layer 2 is 61+5+3=69 bytes, and a minimum packet size of AMR-WB with a minimum bit rate 6.6 kbps at Layer 2 is 18+5+3=26 bytes.

In a scenario in which an uplink coverage is limited, for example, MCS=0, a quantity of resource blocks (Rbnum)=3. A base station (eNB) schedules seven bytes once. In an example in which a TDD configuration is 2, an average quantity of hybrid automatic repeat requests (hybrid automatic repeat request, HARQ) is 4, and a quantity of HARQ processes is 2, seven bytes can be transmitted every 20 ms on average.

In an AMR-NB scenario, even if RoHC is steady compression, an amount of enqueued voice data is 40/7 =5.7 times an amount of dequeued voice data, and a total amount of enqueued voice data is 5.7×20=135 ms, Consequently, the voice data is accumulated,

In an AMR-WB scenario, even if robust header compression (RoHC) is steady compression, an amount of enqueued voice data is 69/7=9.8 times an amount of dequeued voice data. A total amount of enqueued voice data is 9.8×20=196 ms. Even if a rate is adjusted to a minimum rate, the amount of enqueued voice data is 26/7=3.7 times of the amount of dequeued voice data. The total amount of enqueued voice data is 3.7×20=74 ms. Because rate adjustment is triggered only when PDCPs are accumulated to 80%, an actual amount of accumulated voice data in AMR-WB is greater than that in AMR-NB.

Based on the foregoing data, one SID frame is generated every 160 ms. Therefore, cutting off the SID frame can relieve accumulation of voice data. However, a size of an SID frame is 15 bytes, and the SID frame needs to be transmitted by using 15/7×20=43 ms. Therefore, cutting off consecutive SID frames can accelerate relieving accumulation of voice data.

It should be noted that, the technical solutions in the embodiments of the present invention may not only be applied to the AMR-NB and AMR-WB scenarios, but also may be applied to all vocoders, for example, an EVS (enhance voice services) audio encoder and an IVAS (interleaved video and audio stream) after 5G. The IVAS is a network audio and video stream integration system.

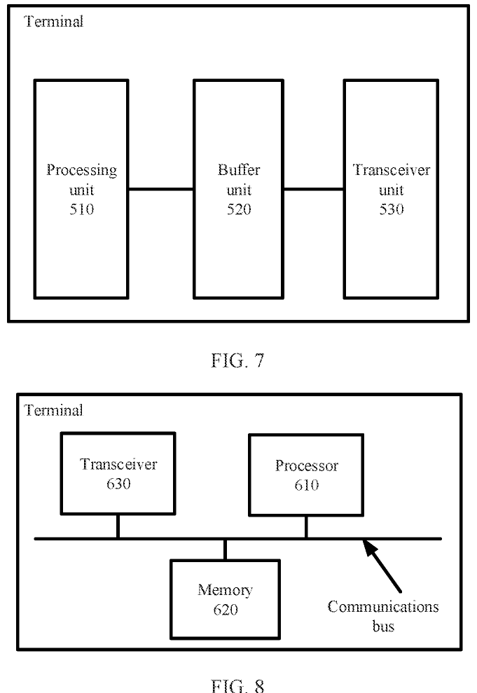

FIG. 1 to FIG. 6 describe the method for improving voice call quality. The following describes a terminal provided in an embodiment of the present invention with reference to FIG. 7 and FIG. 8.

FIG. 7 is a schematic structural diagram of a terminal according to an embodiment of the present invention. As shown in FIG. 7, the terminal includes a processing unit 510 and a buffer unit 520. The buffer unit may also be referred to as a buffer module.

The processing unit 510 is configured to determine that voice data buffered by the buffer module is in an accumulated state.

The processing unit 510 cuts off an SID frame in the voice data. The SID frame does not include semantic data.

When the SID frame is detected and the voice data buffered by the buffer module is in the accumulated state, the SID frame in the voice data is cut off in this way, an amount of to-be-sent voice data is reduced, a packet loss and a sending delay are reduced, voice call quality is further improved, and user experience is improved.

Optionally, in an embodiment, that the processing unit 510 is configured to determine that the voice data buffered by the buffer module is in the accumulated state includes:
when the buffer duration of the voice data buffered by the buffer module meets a first preset threshold, the processing unit 510 determines that the voice data buffered by the buffer module is in the accumulated state.

Optionally, in another embodiment, that the processing unit 510 is configured to determine that the voice data buffered by the buffer module is in the accumulated state includes:
when a ratio of buffer duration of the voice data buffered by the buffer module to maximum allowable buffer duration meets a second preset threshold, the processing unit 510 is configured to determine that the voice data buffered by the buffer module is in the accumulated state, where the maximum allowable buffer duration is used to limit the buffer duration of the buffered voice data.

Optionally, in an embodiment, that the processing unit 510 cuts off the SID frame in the voice data includes:
when at least N consecutive SID frames are detected, the processing unit 510 starts cutting from the (N+1)^{th} SID frame until buffer duration of the buffer module meets a third preset threshold, or until a speech frame is detected, where N is a positive integer, and N is greater than or equal to 0.

In this embodiment of the present invention, the terminal may further include a transceiver unit 530.

Optionally, before it is determined that the voice data buffered by the buffer module is in the accumulated state, the transceiver unit 530 is configured to receive the maximum allowable buffer duration sent by an apparatus, where the maximum allowable buffer duration is used to limit the buffer duration for buffering voice data by the terminal.

Optionally, in an embodiment, the processing unit 510 is further configured to:
discard voice data whose buffer duration exceeds the maximum allowable buffer duration in the buffer module, where the maximum allowable buffer duration is used to limit the buffer duration for buffering the voice data.

Optionally, in an embodiment, a receiving unit 530 is configured to receive authorization information sent by the apparatus.

The processing unit 510 is configured to: determine a quantity of to-be-sent bytes based on the authorization information, obtain, from buffered data, voice data corresponding to the quantity of to-be-sent bytes, and send the voice data to the apparatus,
Optionally, in this embodiment of the present invention, the voice data may be voice data of a 5G call, or may be voice data of a video call.

Functions of function units of the terminal may be implemented by using steps performed by the terminal in the embodiments shown in FIG. 1 to FIG. 6, Therefore, a specific working process of the terminal provided in this embodiment of the present invention is not described herein again.

FIG. 8 is a schematic structural diagram of another terminal according to an embodiment of the present invention. The terminal includes a processor 610. The processor 610 is coupled to a memory 620, and reads and executes an instruction in the memory, to implement the following operations:
determining that voice data buffered by a buffer module is in an accumulated state; and
cutting off an SID frame in the voice data, where the SID frame does not include semantic data.

When the SID frame is detected and the voice data buffered by the buffer module is in the accumulated state, the SID frame in the voice data is cut off. In this way, an amount of to-be-sent voice data is reduced, a packet loss and a sending delay are reduced, voice call quality is further improved, and user experience is improved.

Optionally, in an embodiment, the determining that voice data buffered by a buffer module is in an accumulated state includes:
when buffer duration of the voice data buffered by the buffer module meets a first preset threshold, determining that the voice data buffered by the buffer module is in the accumulated state.

Optionally, in another embodiment, the determining that voice data buffered by a buffer module is in an accumulated state includes:
when a ratio of buffer duration of the voice data buffered by the buffer module to maximum allowable buffer duration meets a second preset threshold, determining that the voice data buffered by the buffer module is in the accumulated state, where the maximum allowable buffer duration is used to limit the buffer duration of the buffered voice data.

Optionally, in an embodiment, the cutting off an SID frame in the voice data includes:
when at least N consecutive SID frames are detected, starting cutting from the (N+1)^{th} SID frame until buffer duration of the buffer module meets a third preset threshold, or until a speech frame is detected. where N is a positive integer, and N is greater than or equal to 0.

Optionally, in an embodiment, before the determining that voice data buffered by a buffer module is in an accumulated state, the processor reads and executes the instruction in the memory, to implement the following operation:
receiving the maximum allowable buffer duration sent by an apparatus, where the maximum allowable buffer duration is used to limit the buffer duration for buffering voice data by the terminal.

In an embodiment, the terminal may further include a transceiver 630. The processor 610 reads an instruction in the memory, and controls the transceiver 630 to receive the maximum allowable buffer duration sent by the apparatus.

Optionally, in an embodiment, the processor reads and executes the instruction in the memory, to implement the following operation:
discarding voice data whose buffer duration exceeds the maximum allowable buffer duration in the buffer module, where the maximum allowable buffer duration is used to limit the buffer duration for buffering the voice data.

Optionally, in an embodiment, the processor reads and executes the instruction in the memory, to implement the following operation:
receiving authorization information sent by the apparatus; and
determining a quantity of to-be-sent bytes based on the authorization information, obtaining, from buffered data, voice data corresponding to the quantity of to-be-sent bytes, and sending the voice data to the apparatus.

Optionally, in this embodiment of the present invention, the voice data may, be voice data of a 5G call, or may be voice data of a video call.

In this embodiment of the present invention, the terminal further includes the memory 620. In an embodiment, the processor 610 and the memory 620 are connected through a communications bus, and are configured to communicate with each other.

Functions of function devices of the terminal may be implemented by using steps performed by the terminal in the embodiments shown in FIG. 1 to FIG. 6. Therefore, a specific working process of the terminal provided in this embodiment of the present invention is not described herein again.

Optionally, in this embodiment of the present invention, the processor may be a central processing unit (central processing unit, CPU), a general purpose processor, a digital signal processor (digital signal processor, DSP), an application-specific integrated circuit (application specific integrated circuit, ASIC), a field programmable gate array (field programmable gate array, FPGA) or another programmable logical device, a transistor logical device, a hardware component, or any combination thereof. The processor may implement or execute various example logical blocks, modules, and circuits described with reference to content disclosed in this application. Alternatively, the processor may be a combination of processors implementing a computing function, for example, a combination of one or more microprocessors, or a combination of a DSP and a microprocessor. Optionally, the processor may include one or more processor units. Optionally, the processor may integrate an application processor and a modem processor. The application processor mainly processes an operating system, a user interface, an application program, and the like. The modem processor mainly processes wireless communication. It may be understood that the modem processor may alternatively not be integrated into the processor.

The memory may be configured to store a software program and a module. The processor runs the software program and the module stored in the memory to perform various function applications of a mobile phone and data processing. The memory may mainly include a program storage area and a data storage area. The program storage area may store an operating system, an application program required for at least one function (such as a sound playing function or an image playing function), and the like. It is assumed that the terminal is a mobile phone. The data storage area may store data (such as audio data or a phone book) created based on use of the mobile phone, and the like. In addition, the memory may include a volatile memory, for example, a nonvolatile dynamic random access memory (Nonvolatile Random Access Memory, NVRAM), a phase-change random access memory (Phase Change RAM, PRAM), and a magnetoresistive random access memory (Magnetoresistive RAM, MRM). The memory may further include a nonvolatile memory, for example, an electrically erasable programmable read-only memory (Electrically Erasable Programmable Read-Only Memory, EEPROM), a flash memory device such as a NOR flash memory (NOR flash memory) or a NAND flash memory (NAND flash memory), or a semiconductor device such as a solid state disk (Solid State Disk, SSD). The memory may further include a combination of the foregoing types of memories.

An embodiment of the present invention further provides a system. The system includes the terminal shown in FIG. 8 and an apparatus, The apparatus is configured to receive voice data sent by the terminal.

Optionally, in this embodiment of the present invention, the apparatus may be a base station or a server, for example, a server used for uplink transmission, for example, a server of a live broadcast website used by a streamer.

An embodiment of the present invention provides a computer program product including an instruction. When the instruction is run on a computer, the methods/steps in FIG. 1 to FIG. 6 are performed.

An embodiment of the present invention provides a computer readable storage medium, configured to store an instruction. When the instruction is executed on a computer, the methods/steps in FIG. 1 to FIG. 6 are performed.

All or some of the foregoing embodiments may be implemented by using software, hardware, firmware, or any combination thereof. When software is used to implement the embodiments, the embodiments may be implemented completely or partially in a form of a computer program product. The computer program product includes one or more computer instructions. When the computer program instructions are loaded and executed on a computer, the procedure or functions according to the embodiments of the present invention are all or partially generated. The computer may be a general purpose computer, a dedicated computer, a computer network, or other programmable apparatuses. The computer instructions may be stored in a computer readable storage medium or may be transmitted from one computer readable storage medium to another computer readable storage medium. For example, the computer instruction may be transmitted. from one website, computer, server, or data center to another website, computer, server, or data center in a wired (for example, a coaxial cable, an optical fiber, or a digital subscriber line (DSL)) or wireless (for example, infrared, radio, or microwave) manner. The computer readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid state disk), or the like.

The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

1. A method for improving voice call quality, implemented by a terminal, wherein the method comprises:
receiving a maximum allowable buffer duration from an apparatus, wherein the maximum allowable buffer duration limits a buffer duration for voice data of a buffer of the terminal;
buffering the voice data according to the maximum allowable buffer duration;
determining that the voice data is in an accumulated state; and
cutting off a first silence insertion descriptor (SID) frame in the voice data,
wherein the first SID frame does not comprise semantic data.

2. The method of claim 1, further comprising determining that the voice data is in the accumulated state when the buffer duration meets a first preset threshold.

3. The method of claim 1, further comprising determining that the voice data is in the accumulated state when a ratio of the buffer duration to the maximum allowable buffer duration meets a second preset threshold.

4. The method of claim 1 further comprising:
detecting a plurality of SID frames in the voice data, wherein the SID frames are consecutive; and
cutting off, in response to detecting the SID frames, from a second SID frame in the voice data until the buffer duration meets a third preset threshold.

5. (canceled)

6. The method of claim 1, wherein the voice data is of a fifth generation (5G) call.

7. A terminal, comprising:
a buffer comprising voice data;
a processor coupled to the buffer; and
a memory coupled to the processor and configured to store instructions that, when executed by the processor, cause the terminal to be configured to:
receive a maximum allowable buffer duration from an apparatus, wherein the maximum allowable buffer duration limits a buffer duration for the voice data;
buffer the voice data according to the maximum allowable buffer duration;
determine that voice data is in an accumulated state; and
cut off a first silence insertion descriptor (SID) frame in the voice data, wherein the first SID frame does not comprise semantic data.

8. The terminal of claim 7, wherein the instructions further cause the terminal to be configured to determine that the voice data is in the accumulated state when the buffer duration meets a first preset threshold.

9. The terminal of claim 7, wherein the instructions further cause the terminal to be configured to determine that the voice data is in the accumulated state when a ratio of the buffer duration to the maximum allowable buffer duration meets a second preset threshold.

10. The terminal of claim 7, wherein the instructions further cause the terminal to be configured to:
detect a plurality of SID frames in the voice data, wherein the SID frames are consecutive; and
cut off, in response to detecting the SID frames, from a second SID frame in the voice data until the buffer duration meets a third preset threshold.

11. (canceled)

12. The terminal of claim 7, wherein the voice data is voice data of a fifth generation (5G) call or of a video call.

13.-17. (canceled)

18. A computer program product comprising computer-executable instructions stored on a non-transitory computer-readable medium that, when executed by a processor, cause a terminal to:
receive a maximum allowable buffer duration from an apparatus, wherein the maximum allowable buffer duration limits a buffer duration for voice data of a buffer of the terminal;
buffer the voice data according to the maximum allowable buffer duration;
determine that the voice data is in an accumulated state; and
cut off a first silence insertion descriptor (SID) frame of the voice data,
wherein the first SID frame has no semantic data.

19. The computer program product of claim 18, wherein the instructions further cause the terminal to determine that the voice data is in the accumulated state when the buffer duration meets a first preset threshold.

20. The computer program product of claim 18, wherein the instructions further cause the terminal to determine that the voice data is in the accumulated state when a ratio of the buffer duration to the maximum allowable buffer duration meets a second preset threshold.

21. The computer program product of claim 18, wherein the instructions further cause the terminal to:
detect a plurality of SID frames of the voice data, wherein the SID frames are consecutive; and
cut off, in response to detecting the SID frames, from a second SID frame in the voice data until the buffer duration meets a third preset threshold.

22. The computer program product of claim 18, wherein the instructions further cause the terminal to:
detect a plurality of SID frames in the voice data, wherein the SID frames are consecutive;
detect whether the voice data comprises a speech frame; and
cut off, in response to detecting the SID frames, from a second SID frame in the voice data until the speech frame is detected.

23. The computer program product of claim 18, wherein the voice data is of a fifth generation (5G) call.

24. The computer program product of claim 18, wherein the voice data is of a video call.

25. The method of claim 1, further comprising:
detecting a plurality of SID frames in the voice data, wherein the SID frames are consecutive;
detecting whether the voice data comprises a speech frame; and
cutting off, in response to detecting the SID frames, from a second SID frame in the voice data until the speech frame is detected.

26. The method of claim 1, wherein the voice data is of a video call.

27. The terminal of claim 7, wherein the instructions further cause the terminal to be configured to:
detect a plurality of SID frames in the voice data, wherein the SID frames are consecutive;
detect whether the voice data comprises a speech frame; and
cut off, in response to detecting the SID frames, from a second SID frame in the voice data until the speech frame is detected.
